(19) United States
(12) Patent Application Publication
(10) Pub. No.: US 2017/0366627 A1
(43) Pub. Date: Dec. 21, 2017

(54) SYSTEM FOR EXECUTING ACTION FEEDBACK AND AN ACTION FEEDBACK METHOD

(71) Applicant: International Business Machines Corporation, Armonk, NY (US)

(72) Inventors: Yuk Lung Chan, ROCHESTER, NY (US); Heidi Lagares-Greenblatt, Jefferson Hills, PA (US); Jenny S. Li, Danbury, CT (US); Xinlin Wang, Irvine, CA (US)

(21) Appl. No.: 15/187,200

(22) Filed: Jun. 20, 2016

(51) Int. Cl. H04L 29/08; H04L 12/58; H04M 1/725

(52) U.S. Cl. CPC H04L 67/22; H04M 1/72569; H04L 51/046; H04L 51/12

(57) ABSTRACT

A system for executing action feedback is provided. The system includes a wearable device that includes a sensor for monitoring a user and generation of user data based on the monitoring, a first networked device coupled to a network and controllable by the user for taking an action and a second networked device coupled to the network. The second networked device is configured to determine whether the user data suggests that the user is experiencing a personal condition of concern and is taking an action with respect to the first networked device and to interrupt a taking of a portion of the action based on the portion of the action being compromised by at least one of the personal condition of concern and characteristics of social networks of the user.

### BACKGROUND

The present invention relates to a system for executing action feedback and an action feedback method and, more specifically, to a system for executing action feedback that interrupts a taking of a portion of an action that is compromised by at least one of a personal condition of concern and characteristics of social networks of a user.

Wearable computers are systems that are carried by a user and may include one or more of central processing units (CPUs), hard drives, power supplies and input/output (I/O) devices. Such systems are under development and their sizes and weights are being reduced even as their durability is being improved. The systems are also being built in concert with clothing and accessories (such as watches, jewelry, etc.) such that the systems can be built into or embedded within a user's clothes or accessories. This way, the systems can be mode unobtrusive and comfortable as well as invisible.

Wearable computers such as those being developed will allow for the creation of systems that go where the user goes, whether that means home, office, gym or any other locale. More importantly, they will provide for a platform that can maintain constant contact with the user in the variety of ways that the system may require while also providing for computing power for various computing needs, sensing applications that can interpret, understand and use various types of data and storing applications and user input data in on-board memory. Finally, such systems can link to personal computers and to the Internet, thus providing for versatility of communications and applications.

### SUMMARY

According to an embodiment of the present invention, a system for executing action feedback is provided. The system includes a wearable device that includes a sensor for monitoring a user and generation of user data based on the monitoring, a first networked device coupled to a network and controllable by the user for taking an action and a second networked device coupled to the network. The second networked device is configured to determine whether the user data suggests that the user is experiencing a personal condition of concern and is taking an action with respect to the first networked device and to interrupt a taking of a portion of the action based on the portion of the action being compromised by at least one of the personal condition of concern and characteristics of social networks of the user.

According to another embodiment, an action feedback method is provided and includes activating a sensor of a wearable computing device of a user to monitor the user and to generate user data based thereon, determining whether the user data suggests that the user is experiencing a personal condition of concern and whether the user is taking an action with respect to a networked device and interrupting a taking of a portion of the action based on the portion of the action being compromised by at least one of the personal condition of concern and characteristics of social networks of the user.

According to another embodiment, an action feedback method is provided and includes activating a sensor of a wearable computing device of a user to monitor the user, generating user data based on monitoring of the user by the sensor, determining whether the user data suggests that the user is experiencing a personal condition of concern, determining whether the user is taking an action with respect to a networked device, analyzing the personal condition of concern and characteristics of social networks of the user, identifying that a portion of the action is compromised by at least one of the personal condition of concern and the characteristics of the social networks and interrupting a taking of the portion of the action.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a schematic illustration of a system for executing an action feedback method in accordance with embodiments;

FIG. 2 is a schematic diagram of a wearable device of a user in accordance with embodiments;

FIG. 3 is a schematic diagram of a networked device of a user in accordance with embodiments;

FIG. 4 is a graphical illustration of temporal and active patterns and periodically updatable pattern thresholds;

FIG. 5 is a schematic diagram of an operation of a processing circuit in accordance with embodiments;

FIG. 6 is an example of a warning issued to a user who is attempting to send a text message in an upset state; and

FIG. 7 is a flow diagram illustrating an action feedback method in accordance with embodiments.

### DETAILED DESCRIPTION

As networked devices become more and more common throughout society, people will need to be safeguarded against taking actions that are harmful to themselves when they are in an unstable state. For example, if someone is upset about something negative happening in their social life, they might need to be prevented from or delayed before sending an email using their mobile phone. On the other hand, a person who has been fired from their job might need to be prevented from or delayed before sending an angry text to a family member who has done nothing wrong.

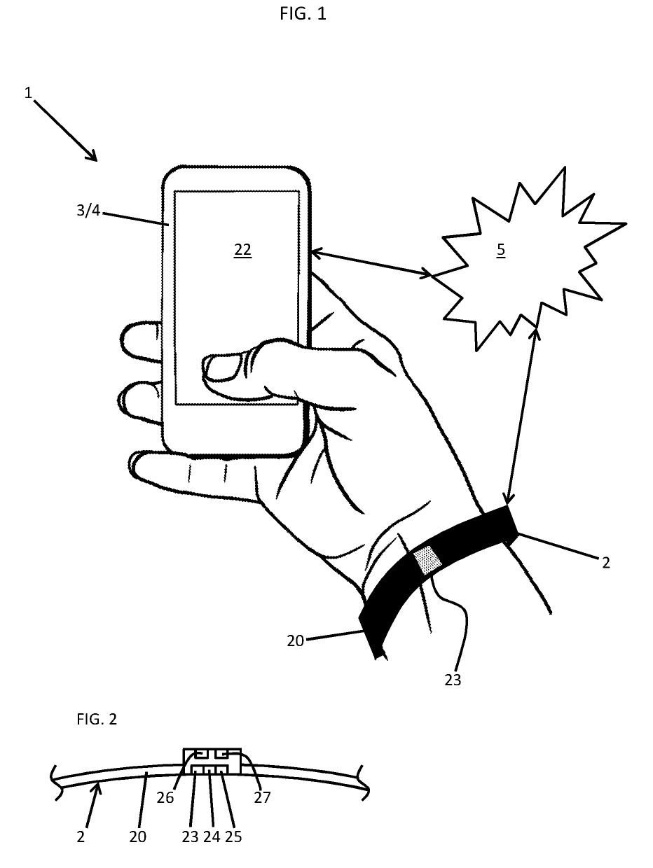

Therefore, with reference to FIG. 1, an awareness system 1 is provided that alerts users when taking actions during unstable physiological or emotional states. The system will collect data from user's wearables to understand if the user is currently in an unstable physiological or emotional state and will connect to Internet-of-Things (IoT) sensors in order to determine if the user is taking any particular actions (e.g., making a call, sending an email, deleting files, buying items over the internet, etc). The system will automatically detect relationships between the user and intended or other potential recipients or targets of the action being taken, if any. Such relationships can be discovered from address books, social networks, company directories, etc. It can also include interaction frequency data. In any case, the system would be capable of real-time interruption of the user's action based on the user's physiological or emotional state and the relationship between the user and the intended recipient or target.

The system 1 is thus capable of executing action feedback for the user and includes one or more wearable devices 2, one or more first networked devices 3 and one or more second networked devices 4. For purposes of clarity and brevity, the following description and the drawings will refer to only a single wearable device 2 and to singular first and second networked devices 3 and 4 but it is to be understood that this is not meant to limit the description in any way, shape or form.

In an exemplary case, the system 1 will detect if an action taken by a user (such as the sending of an email) targeting a close personal friend or family member is a personal action instead of a professional action (such as the sending of an email to a coworker) to then help the user with a notification about the action. The system 1 may determine that the user is experiencing a physiological or emotional state that is outside their normal threshold state with feedback reacting to the user taking the personal or professional actions. Thus, if the user starts typing an email over their mobile phone, a feedback mechanism in their mobile phone or smart watch can vibrate or provide a quick message alerting the user that they are making a decision while outside their threshold state. The user can then decide if they want to continue with the action or not.

In accordance with embodiments, the system 1 will be configured to run in a CPU or in some integrated cloud computing service by way of, for example, a cellphone, a smart watch, a computer, Bluetooth™, etc.) and will connect to the user's mobile devices, wearables and IoT devices.

With additional reference to FIG. 2, the wearable device 2 may be provided as a fitness tracker 20, such as a Fitbit™, that the user wears on his arm during the day, to a smart watch, a mobile computing device 22 (see FIG. 1) or any other electronic device that the user keeps on his person during the day. In any case, the wearable device 2 may include a sensor 23, a global positioning system (GPS) or geo-location system unit 24 and a processing circuit 25. The sensor 23 monitors any one or more physical or emotional characteristics of the user and thereby generates user data that is based on the monitoring. Such user data may be reflective of, for example, body temperature, heartbeat blood pressure, breathing rhythms, sleeping patterns and physical changes like smiles, cries, swelling, etc. The geo-location system unit 24 may be configured to determine in real-time a location of the user relative to a predefined location. The processing circuit 25 controls various operations of the sensor 23, the geo-location system 24, an input/output (I/O) unit 26, a networking unit 27 by which the wearable device 2 is communicate with external elements and the execution of one or more applications.

In accordance with alternative embodiments, the wearable device 2 may be provided as jewelry, clothing, personal accessories, etc. In each case, the structure and configuration of the wearable device 2 may be generally similar to what is described above.

The first networked device 3 may be coupled to a network 5, such as the cloud and/or the Internet, and is controllable by the user for taking any one or more predefined actions. The second networked device 4 may also be coupled to the network 5 and is configured to execute certain functionality. That is, the second networked device 4 may be configured to determine whether the user data generated by the wearable device 2 suggests that the user is currently experiencing a personal condition of concern and whether the user is currently or about to take an action with respect to the first networked device 4. In addition, the second networked device 4 may be configured to interrupt a taking of at least a portion of the action based on the portion of the action being found to be compromised by at least one of the personal condition of concern and characteristics of social networks of the user.

In accordance with embodiments, at least one of the first and second networked devices 3 and 4 may include or be provided as a portable computing device 304 such as a cell phone, a tablet, a portable computer or an IoT device. In some cases, the first and second networked devices 3 and 4 may include components of or be provided as components of the same portable computing device 304 and in still other cases may be the mobile computing device 22 of FIG. 1.

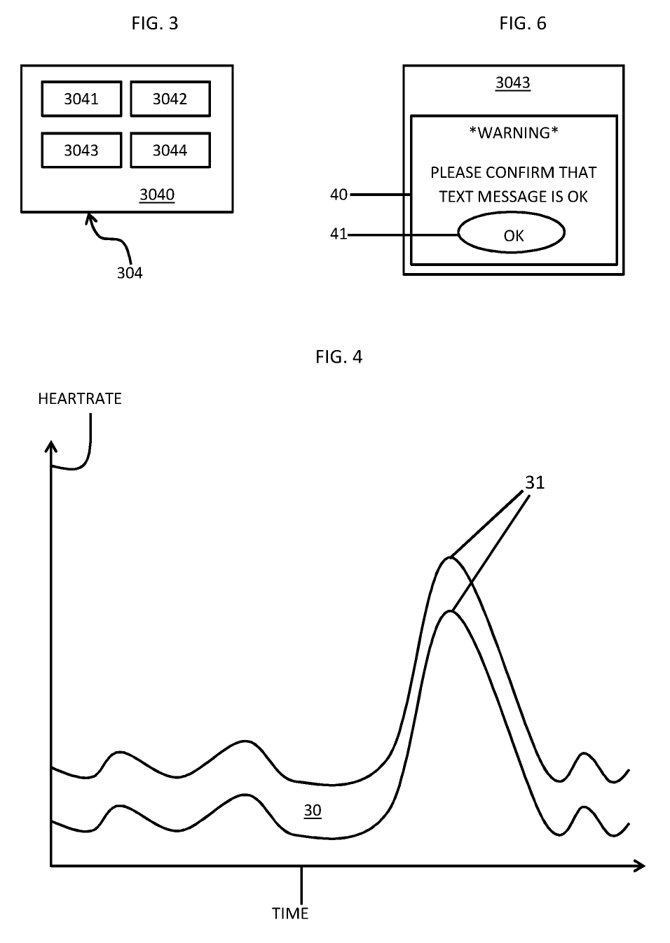

In any case, with reference to FIG. 3, the portable computing device 304 may include a housing 3040, a processing circuit 3041, a memory 3042, an input/output element 3043 and a networking unit 3044. The processing circuit 3041, the memory 3042, the input/output element 3043 and the networking unit 3044 are all generally housed within the housing 3040, the networking unit 3044 allows for communication between the portable computing device 304 and the network 5 or other networks, the input/output element 3043 facilitates an interface between the user and the portable computing device 304, and the memory 3042 has read-only and read/write access storage capability on which executable instructions are stored. The processing circuit 3041 controls various operations of the input/output element 3043 and the networking unit 3044 in accordance with user inputted commands and the executable instructions as described herein.

In particular, the executable instructions may cause the processing circuit 3041 of the second networked device 4 to collect the user data itself, to collect the user data directly from the wearable device 2 or to collect the user data from the wearable device 2 via the network 5 and to determine that the user data is suggestive of a problematic situation. That is, the executable instructions may cause the processing circuit 3041 to determine from the user data that the user is currently experiencing the personal condition of concern in terms of the user's physiological or emotional condition based on predefined and historical characteristics of the user data. For example, if the user's body temperature and heartbeat are elevated in comparison with their normal body temperature and heartbeat and the user has not been exercising and is otherwise healthy, the processing circuit 3041 may determine that the user is currently experiencing stress, disappointment or fear.

In greater detail, with reference to FIG. 4, the executable instructions may cause the processing circuit 3041 to determine that the user data suggests that the user is currently experiencing the personal condition of concern by mapping behaviors or physical conditions of the user to the user data to generate temporal and active patterns 30 and to define periodically updatable pattern thresholds 31 from clustering analysis executed with respect to the temporal and active patterns 30. Thus, as shown in FIG. 4, a user's heartbeat might be generally low and consistent throughout the day except for the hours between 6 PM and 7 PM when the user is normally exercising. At these points, the user's heartbeat can fluctuate relatively widely in accordance with daily variations in the user's workout routine without exceeding safe limits.

From such historical perspective, the executable instructions can cause the processing circuit 3041 to infer that an elevated heartbeat that fluctuates widely between 6 PM and 7 PM is normal and expected. As such, if the user's heartbeat becomes elevated and begins to fluctuate outside of the pattern thresholds 31 at 11 AM when the user is usually at work, the executable instructions may cause the processing circuit 3041 to determine that the user is experiencing stress at work.

Once the processing circuit 3041 determines that the user is experiencing the personal condition of concern, the processing circuit 3041 analyzes a type and degree of the personal condition of concern and analyzes relationship types and degrees in the characteristics of the social networks of the user. Here, such analysis of the type and degree of the personal condition of concern may include a continued monitoring of vital statistics of the user as well as any audible noises (e.g., cries) uttered by the user and/or unexpected movements taken by the user (e.g., storming out of his office). Meanwhile, the analysis of the relationship types and degrees in the characteristics of the social networks of the user may involve reviewing social networking accounts and available business information to thereby identify work colleagues and personal friendships and to identify which of those work colleagues are friends and vice versa and which friends are close friends or merely acquaintances, etc.

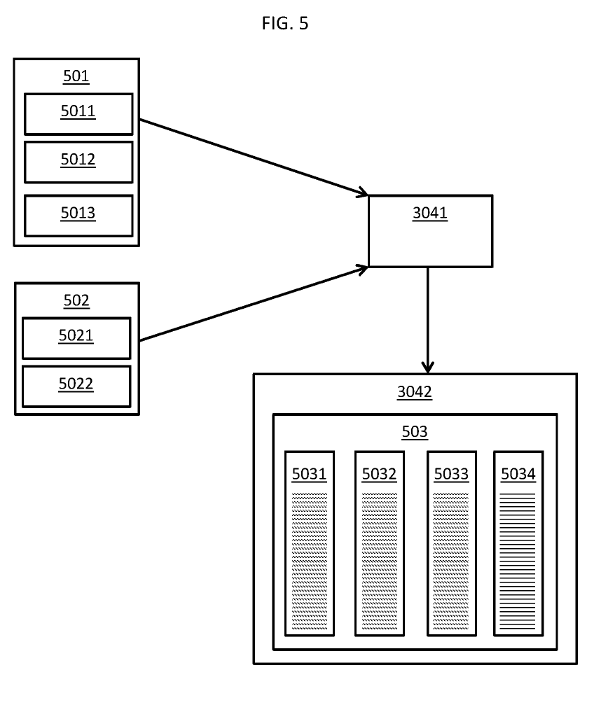

For example and with reference to FIG. 5, the user may have multiple social networks 501 and online presences 502. As shown in FIG. 5, the social networks 501 may include a Facebook™ profile 5011, a linked-in profile 5012 and a dating website profile 5013 while the online presences 502 may include a first website 5021 that lists the user as an employee along with other employees and a second website 5022 that identifies the user as a contributor (e.g., a website of a non-profit agency). In such cases, the processing circuit 3041 can generate within the memory 3042 a database 503 of the user's friends 5031, acquaintances 5032, colleagues 5033, competitors 5034, etc., with the understanding that there may be some overlaps among each. This could be done, for example, by the processing circuit 3041 initially creating simple lists of the user's social connections from rough collections of certain broad information about each individual the user has a connection to (i.e., by listing the user's Facebook™ friends as friends 5031), then by fine tuning or pairing down those lists (i.e., by reviewing actual online interactions with those individuals) and finally by ranking remaining individuals in the lists.

Thus, a co-employee of the user that is also a Facebook™ friend may be initially listed as a friend and a colleague. If that person is also someone who the user regularly text messages and communicates with freely using public Facebook™ posts, the processing circuit 3041 may determine that the person should be listed as both a friend 5031 and a colleague 5033 and that the person could potentially be highly ranked on the list of friends 5031. By contrast, a family member of the user that the user is a Facebook™ friend of but almost never communicates with could be listed as a friend 5031 by the processing circuit 3041 but ranked relatively low.

Based on results of the analysis, the executable instructions cause the processing circuit 3041 to interrupt the taking of at least the portion of the action based on the portion of the action being found to be compromised by at least one of the personal condition of concern and characteristics of social networks of the user. That is, if the user has been upset by something at work and is found to be using his cell phone (as the first networking device 3) to send a text message in his upset state to his entire set of Facebook™ friends including both close friends that he would normally confide in and groups of personal but distant friends that he would not normally confide in, the processing circuit 3041 will interrupt the sending of the text message to at least the groups of personal but distant friends. On the contrary, if the user is upset by something happening in his personal life and is using his cell phone (again acting as the first networking device 3) to send an email addressed to the entire staff of his employer, the processing circuit 3041 will interrupt the sending of the email.

Returning to the examples given above in the description of FIG. 5, if the user has been upset by something at work and is found to be using his cell phone (as the first networking device 3) to send a text message in his upset state to his entire set of Facebook™ friends including both close friends that he would normally confide in and groups of personal but distant friends that he would not normally confide in, the processing circuit 3041 might interrupt the sending of the text message to anyone other than the highest ranked friends 5031 and might question the user about sending the text message to the highly ranked friends who are also colleagues. Similarly, if the user is upset by something happening in his personal life and is using his cell phone (again acting as the first networking device 3) to send an email addressed to the entire staff of his employer, the processing circuit 3041 will interrupt the sending of the email but might question the user about sending the email to the colleague who is also listed as a highly ranked friend 5031.

With reference to FIG. 6, the interruptions may take the form of a warning 40 and/or a complete blocking and cancellation of the text message or email. In accordance with further embodiments, however, the processing circuit 3041 may be configured to receive an override command 41 from the user and to permit the taking of at least the portion of the action based on the receipt of the override command 41.

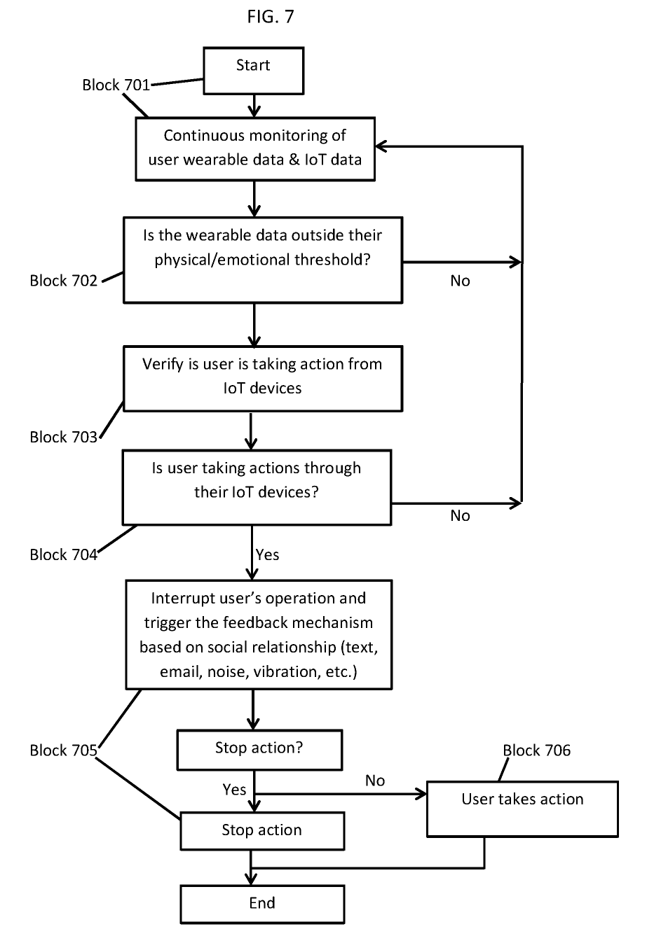

With reference to FIG. 7, an action feedback method is provided. As shown in FIG. 7, the action feedback method includes initially activating a sensor of a wearable computing device of a user to continuously monitor various physiological and emotional states of the user and generating user data based on monitoring of the user by the sensor at block 701. The method further includes determining whether the user data suggests that the user is currently experiencing a personal condition of concern at block 702 and determining whether the user is taking an action with respect to a networked device at block 703.

At this point, in an event the user is experiencing the personal condition of concern and is taking an action with respect to the networked device, the personal condition of concern and the characteristics of social networks of the user are analyzed to identify that at least a portion of the action is compromised by at least one of the personal condition of concern and the characteristics of the social networks and the taking of at least the portion of the action is interrupted at block 704. Such interrupting may include, for example, issuing a warning and blocking the taking of the portion of the action at block 705 or receiving an override command and permitting the taking of the portion of the action based on the override command at block 706.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A system for executing action feedback, comprising:
a wearable device comprising a sensor for monitoring a user and generation of user data based on the monitoring;
a first networked device coupled to a network and controllable by the user for taking an action; and
a second networked device coupled to the network and configured to:
determine whether the user data suggests that the user is experiencing a personal condition of concern and is taking an action with respect to the first networked device, and
interrupt a taking of a portion of the action based on the portion of the action being compromised by at least one of the personal condition of concern and characteristics of social networks of the user.

2. The system according to claim 1, wherein the wearable device comprises a fitness tracker that continuously monitors physiological and emotional characteristics of the user.

3. The system according to claim 1, wherein at least one of the first and second networked devices comprises a cell phone, a tablet or a portable computer.

4. The system according to claim 1, wherein the first and second networked devices comprise components of a same computing device.

5. The system according to claim 1, wherein the second networked device is configured to determine that the user data suggests that the user is currently experiencing the personal condition of concern based on predefined and historical characteristics of the user data.

6. The system according to claim 1, wherein the second networked device is configured to:
determine that the user data suggests that the user is currently experiencing the personal condition of concern by mapping behaviors to the user data to generate temporal and active patterns, and
define periodically updatable pattern thresholds from clustering analysis executed with respect to the temporal and active patterns.

7. The system according to claim 1, wherein the second networked device is configured to analyze a type and degree of the personal condition of concern and analyze relationship types and degrees in the characteristics.

8. The system according to claim 1, wherein the second networked device is configured to:
interrupt the taking of the portion of the action by issuing a warning and block the taking of the portion of the action, and
receive an override command and permit the taking of the portion of the action based on the override command.

9. An action feedback method, comprising:
activating a sensor of a wearable computing device of a user to monitor the user and to generate user data based thereon;
determining whether the user data suggests that the user is experiencing a personal condition of concern and whether the user is taking an action with respect to a networked device; and
interrupting a taking of a portion of the action based on the portion of the action being compromised by at least one of the personal condition of concern and characteristics of social networks of the user.

10. The action feedback method according to claim 9, wherein the sensor continuously monitors physiological and emotional characteristics of the user.

11. The action feedback method according to claim 9, wherein the determining of whether the user data suggests that the user is currently experiencing the personal condition of concern is based on predefined and historical characteristics of the user data and comprises:
mapping behaviors to the user data to generate temporal and active patterns; and
defining periodically updatable pattern thresholds from clustering analysis executed with respect to the temporal and active patterns.

12. The action feedback method according to claim 9, wherein the taking of the action comprises using the networked device to make a telephone call and sending a text, an email or an instant message from the networked device.

13. The action feedback method according to claim 9, further comprising analyzing a type and degree of the personal condition of concern and analyzing relationship types and degrees in the characteristics.

14. The action feedback method according to claim 9, wherein the interrupting comprises:
issuing a warning and blocking the taking of the portion of the action; and
receiving an override command and permitting the taking of the portion of the action based on the override command.

15. An action feedback method, comprising:
activating a sensor of a wearable computing device of a user to monitor the user;
generating user data based on monitoring of the user by the sensor;
determining whether the user data suggests that the user is experiencing a personal condition of concern;
determining whether the user is taking an action with respect to a networked device;
analyzing the personal condition of concern and characteristics of social networks of the user;
identifying that a portion of the action is compromised by at least one of the personal condition of concern and the characteristics of the social networks; and
interrupting a taking of the portion of the action.

16. The action feedback method according to claim 15, further comprising configuring the sensor to continuously monitor physiological and emotional characteristics of the user.

17. The action feedback method according to claim 15, wherein the determining of whether the user data suggests that the user is currently experiencing the personal condition of concern is based on predefined and historical characteristics of the user data and comprises:
mapping behaviors to the user data to generate temporal and active patterns; and
defining periodically updatable pattern thresholds from clustering analysis executed with respect to the temporal and active patterns.

18. The action feedback method according to claim 15, wherein the taking of the action comprises using the networked device to make a telephone call and sending a text, an email or an instant message from the networked device.

19. The action feedback method according to claim 15, further comprising analyzing a type and degree of the personal condition of concern and analyzing relationship types and degrees in the characteristics.

20. The action feedback method according to claim 15, wherein the interrupting comprises:
issuing a warning and blocking the taking of the portion of the action; and
receiving an override command and permitting the taking of the portion of the action based on the override command.
